(19) United States
(12) Patent Application Publication
(10) Pub. No.: US 2026/0272018 A1
(43) Pub. Date: Sep. 17, 2026

(54) ARTICLE

(71) Applicant: Nicoventures Trading Limited, London (GB)

(72) Inventors: Mark POTTER, London (GB); Richard HEPWORTH, London (GB); Steven SCHENNUM, Naperville, IL (US)

(21) Appl. No.: 19/168,535

(22) PCT Filed: Mar. 28, 2024
(86) PCT No.: PCT/EP2024/058491

§ 371 Date: Sep. 24, 2025

Related U.S. Application Data
(60) Provisional application No. 63/582,098, filed on Sep. 12, 2023.

(30) Foreign Application Priority Data
Mar. 29, 2023 (GB) 2304638.6
Mar. 29, 2023 (GB) 2304648.5
Nov. 20, 2023 (GB) 2317730.6

(51) Int. Cl. A24F 40/46; A24C 5/01; A24D 1/20; A24F 40/20; A24F 40/48; A24F 40/70; H05B 3/26

(52) U.S. Cl. CPC A24F 40/46; A24C 5/01; A24D 1/20; A24F 40/20; A24F 40/48; A24F 40/70; H05B 3/26

(57) ABSTRACT

An article for an aerosol provision device is provided. The article comprises an aerosol generating layer comprising aerosol generating material, a resistive heating layer comprising a resistive heating element configured to heat at least a portion of the aerosol generating material to generate an aerosol, the aerosol generating layer being on the resistive heating layer, a first type of electrical contact, and a second type of electrical contact. The resistive heating element is at least a portion of an electrically conductive path between the first type of electrical contact and the second type of electrical contact. The article comprises an internal space defining a path along which, in use, aerosol generated from the aerosol generating layer is configured to flow.

### CROSS-REFERENCE TO RELATED APPLICATIONS

This present application is a National Phase entry of PCT Application No. PCT/EP2024/058491, filed 28 Mar. 2024, which claims priority from Great Britain Application No. 2304638.6, filed 29 Mar. 2023, and which claims priority from Great Britain Application No. 2304648.5, filed 29 Mar. 2023, and which claims priority from U.S. application Ser. No. 63/582,098, filed 12 Sep. 2023, and which claims priority from Great Britain Application No. 2317730.6, filed 20 Nov. 2023, each of which are fully incorporated herein by reference in their entireties.

### TECHNICAL FIELD

The present invention relates to an article for an aerosol provision device. The present application also relates to a blank, and a method of manufacturing an article.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium.

### SUMMARY

In an aspect, there is provided an article for an aerosol provision device. The article comprises an aerosol generating layer comprising aerosol generating material, a resistive heating layer comprising a resistive heating element configured to heat at least a portion of the aerosol generating material to generate an aerosol, the aerosol generating layer being on the resistive heating layer, a first type of electrical contact, and a second type of electrical contact. The resistive heating element is at least a portion of an electrically conductive path between the first type of electrical contact and the second type of electrical contact. The article comprises an internal space defining a path along which, in use, aerosol generated from the aerosol generating layer is configured to flow.

The article may further comprise a body defining the internal space. The body may be hollow. The body may comprise a support. The resistive heating layer may be on the support. At least a portion of the aerosol generating material may be exposed in the internal space. The body may be tubular.

The aerosol generating layer may be a first aerosol generating layer. The resistive heating layer may be a first resistive heating layer. The article may further comprise a second aerosol generating layer comprising a second aerosol generating material and a second resistive heating layer comprising a second resistive heating element configured to heat at least a portion of the second aerosol generating material to generate an aerosol. The second aerosol generating layer may be on the second resistive heating layer. The second resistive heating element may be at least a portion of an electrically conductive path between the first type of electrical contact and the second type of electrical contact. The internal space may be defined between the first and second resistive heating layers. The first type of electrical contact may comprise a common electrical contact from which both the first and second resistive heating elements extend. The second type of electrical contact may comprise two electrical contacts electrically separate from each other. The first resistive heating element may extend from one of the electrical contacts and the second resistive heating element may extend from the other one of the electrical contacts. The first resistive heating layer may comprise a plurality of first resistive heating elements, each of which is a portion of a respective electrically conductive path between a respective first type of electrical contact and one of the electrical contacts of the second type of electrical contact. The second resistive heating layer may comprise a plurality of second resistive heating elements, each of which is a portion of a respective electrically conductive path between a respective first type of electrical contact and the other electrical contact of the second type of electrical contact. The body may be disposed between the first and second resistive heating layers.

The article may further comprise a connecting portion coupled to the first resistive heating layer by a first fold at one end and coupled to the second resistive heating layer by a second fold at the other end. Each of the connecting portion and the first and second resistive heating layers may be formed from a single sheet of material.

The first and second resistive heating layers may face each other.

The article may further comprise an aerosol generator positioned in the internal space between the first and second resistive heating layers. The aerosol generator may comprise a third aerosol generating layer comprising aerosol generating material, a third resistive heating layer comprising a third resistive heating element configured to heat aerosol generating material of the third aerosol generating layer to generate an aerosol, the third aerosol generating layer being on the third resistive heating layer, a fourth aerosol generating layer comprising aerosol generating material, a fourth resistive heating layer comprising a fourth resistive heating element configured to heat at least the aerosol generating material of the fourth aerosol generating layer to generate an aerosol, and the fourth aerosol generating layer being on the fourth resistive heating layer. Each resistive heating element may be at least a portion of an electrically conductive path between a first type of electrical contact and a second type of electrical contact.

The third aerosol generating layer may be positioned spaced apart from the first aerosol generating layer and defines a first airflow path therebetween. The fourth aerosol generating layer may be positioned spaced apart from the second aerosol generating layer and defines a second airflow path therebetween.

The first and second type of electrical contacts of the third and/or fourth resistive heating layers may be displaced along the longitudinal direction from the first and second type of electrical contacts of the first and/or second resistive heating layers.

The second type of electrical contact of the third and/or fourth resistive heating layers may comprise two electrical contacts electrically separate from each other. The third resistive heating element may extend from one of the electrical contacts and the fourth resistive heating element may extend from the other one of the electrical contacts.

The third resistive heating layer may comprise a plurality of third resistive heating elements, each of which is a portion of a respective electrically conductive path between a respective first type of electrical contact and one of the second type of electrical contacts. The fourth resistive heating layer may comprise a plurality of fourth resistive heating elements, each of which is a portion of a respective electrically conductive path between a respective third type of electrical contact and the another of the second type of electrical contact.

The first type of electrical contact may comprise a plurality of electrical contacts. A respective third resistive heating element and a respective fourth resistive heating elements may share a respective one of the plurality of electrical contacts of the first type of electrical contact.

In an embodiment of any of the above, the aerosol generating material may be a solid material. The aerosol generating material may comprise reconstituted tobacco.

In an embodiment of any of the above, the aerosol generating material may comprise may be a semi-solid material. The aerosol generating material may be a gel. The aerosol generating material may be a thin film.

In an embodiment of any of the above, the aerosol generating material may be a non-liquid material.

In an aspect, there is provided an article for an aerosol provision device, the article comprising: aerosol generating material; a resistive heating layer comprising a resistive heating element configured to heat at least a portion of the aerosol generating material to generate an aerosol; the aerosol generating material being on the resistive heating layer; a first type of electrical contact; and a second type of electrical contact; wherein the resistive heating element is at least a portion of an electrically conductive path between the first type of electrical contact and the second type of electrical contact.

The article may comprise an internal space defining a path along which, in use, aerosol generated from the aerosol generating layer is configured to flow.

In yet another aspect, there is provided an aerosol generating system. The aerosol generating system comprises the article as described above and an aerosol provision device configured to receive the article.

In yet another aspect, there is provided a blank for forming an aerosol generating material. The blank comprises one or more resistive heating elements, each of which is configured to generate heat, a first type of electrical contact, a second type of electrical contact. Each of the resistive heating elements is at least a portion of an electrically conductive path between the first type of electrical contact and the second type of electrical contact. The blank is configured to form an internal space defining a path along air can flow. The path is adjacent to the resistive heating element.

The blank may comprise a first region comprising a first resistive heating element configured to generate heat, a second region comprising a second resistive heating element configured to generate heat, a first fold line positioned between the first and second regions, and a second fold line spaced apart from the first fold line and positioned between the first and second regions. Each of the first and second resistive heating elements may be at least a portion of a respective electrically conductive path between a respective first type of electrical contact and a second type of electrical contact. Folding the blank about the first and second fold lines may result in the first and second portions each forming a respective layers where the first and second resistive heating elements facing towards from each other.

The first type of electrical contact may be common to both the first and second regions. The first type of electrical contact may be positioned between the first and second regions. Each of the first and second fold lines may be positioned on the first type of electrical contact.

In yet another aspect, there is provided a method of manufacturing an article. The method comprises providing a blank as described above, depositing an aerosol generating layer comprising aerosol generating material on the first and/or second portions such that the first and/or second resistive heating elements can heat aerosol generating material to generate an aerosol, folding the sheet about the first fold line, and folding the blank about the second fold line.

### BRIEF DESCRIPTION OF THE DRAWINGS

Various embodiments will now be described, by way of example only, with reference to the accompanying schematic drawings, in which:

FIG. 1 is a schematic perspective view of an aerosol provision system;

FIG. 2 is a schematic perspective view of an article comprising aerosol generating material of the aerosol provision system of FIG. 1;

FIG. 3 is a schematic perspective view of a first side of an aerosol generator of the article of FIG. 2;

FIG. 4 is a schematic perspective view of part of a second side of the aerosol generator of FIG. 3;

FIG. 5 is a schematic block diagram of an aerosol provision system such as the system shown in FIG. 1;

FIG. 6 is a schematic partially exploded perspective view of the article of FIG. 2, with an aerosol generator shown inverted from an assembled orientation and in a spaced relationship with other components;

FIG. 7 is a schematic cross-sectional view of another aerosol generator such as the aerosol generator shown in FIG. 3;

FIG. 8 is a schematic plan view of a heating element of the aerosol generator of FIG. 3;

FIG. 9 is a schematic plan view of a resistive heating layer of the aerosol generator of FIG. 3 with a plurality of heating elements;

FIG. 10 is a flow chart showing a method of forming an aerosol generator, such as the aerosol generator of FIG. 3;

FIG. 11 is an exploded perspective view of an aerosol generator being formed;

FIG. 12 is a schematic perspective view of a resistive heating layer of an aerosol generator being formed;

FIG. 13 is a flow chart showing a method of forming an aerosol generator, such as the aerosol generator of FIG. 3;

FIG. 14 is a flow chart showing a method of forming an aerosol generator, such as the aerosol generator of FIG. 3;

FIG. 15 is a flow chart showing a method of forming an aerosol generator, such as the aerosol generator of FIG. 3;

FIG. 16 is a schematic perspective view of a resistive heating layer of an aerosol generator being formed;

FIG. 17 is a schematic perspective view of a back to back aerosol generator;

FIG. 18 is a schematic perspective view of an article having a back to back aerosol generator;

FIG. 19A is a schematic perspective view of a blank for forming a back to back aerosol generator;

FIG. 19B is a schematic perspective view of a close up of a portion of the blank of FIG. 19A;

FIG. 20 is a schematic perspective view of a hollow aerosol generator;

FIG. 21 is a cross-sectional view of another hollow aerosol generator;

FIG. 22A is a schematic perspective view of a blank for forming a hollow aerosol generator;

FIG. 22B is a schematic perspective view of another blank for forming a hollow aerosol generator;

FIG. 22C is a schematic perspective view of another blank for forming a hollow aerosol generator;

FIG. 23A is a schematic perspective view of a various components of an article having a hollow aerosol generator;

FIG. 23B is a schematic perspective view of an article having a hollow aerosol generator cut away to show the interior;

FIG. 24 is a schematic perspective view of a various components of an article having a stack configuration;

FIG. 25A is a schematic perspective view of an article having a stack configuration cut away to show the interior; and

FIG. 25B is a schematic perspective view of the article having a stack configuration.

### DETAILED DESCRIPTION

As used herein, the term “delivery mechanism” is intended to encompass systems that deliver a substance to a user, and includes: non-combustible aerosol provision systems that release compounds from an aerosolisable material without combusting the aerosolisable material, such as electronic cigarettes, tobacco heating products, and hybrid systems to generate aerosol using a combination of aerosolisable materials; and articles comprising aerosolisable material and configured to be used in one of these non-combustible aerosol provision systems.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” (which is sometimes referred to herein as an aerosolisable material) is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

In some embodiments, the substance to be delivered comprises an active substance (sometimes referred to herein as an active compound).

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

The slurry may be heated to remove at least about 60 wt %, 70 wt %, 80 wt %, 85 wt % or 90 wt % of the solvent.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise a material heatable by electrical conduction.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

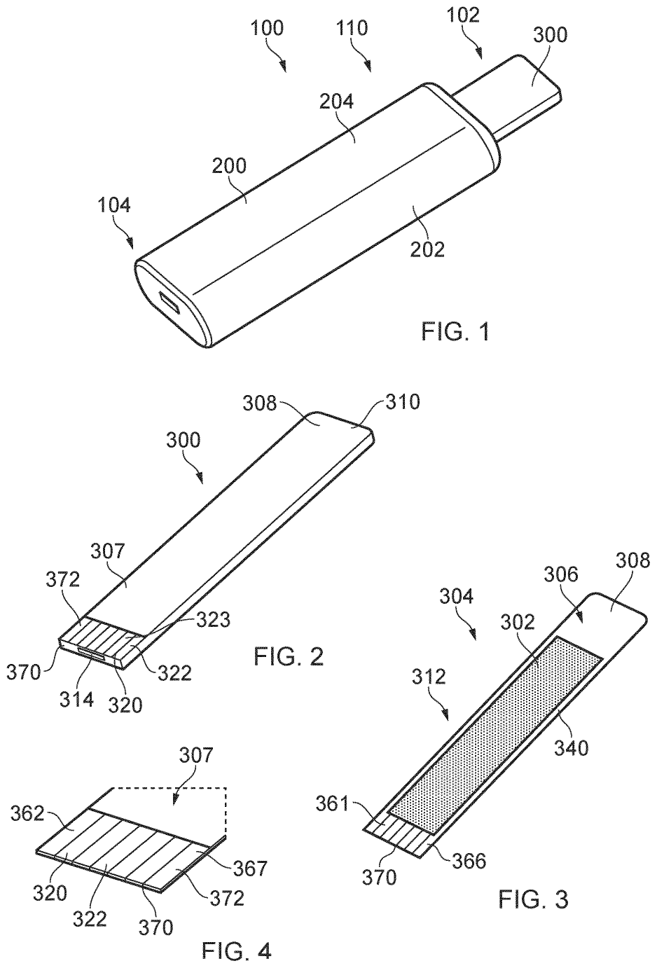

FIG. 1 shows a schematic view of an aerosol provision system 100. The aerosol provision system 100 comprises an aerosol provision device 200 and an article 300 comprising aerosol generating material 302 (refer to FIG. 3). The article 300 is shown in FIG. 2 removed from the aerosol provision device 200. An aerosol generator 304 of the article 300 is shown in FIG. 3 with a perspective view of a first side 306, with a perspective view of part of a second side 307 shown in FIG. 4.

The article 300 comprises the aerosol generator 304. The aerosol generator 304 is configured to generate an aerosol from the aerosol generating material 302 upon operation of the aerosol provision system 100, as will be describe in detail below.

The aerosol provision system 100 may be elongate, extending along a longitudinal axis. The aerosol provision system 100 has a proximal end 102, which will be closest to the user (e.g. the user's mouth) when in use by the user to inhale the aerosol generated by the aerosol provision system 100, and a distal end 104 which will be furthest from the user when in use.

The proximal end may also be referred to as the “mouth end”. The aerosol provision system 100 accordingly defines a proximal direction, which is directed towards the user when in use. Further, the aerosol provision system 100 likewise defines a distal direction, which is directed away from the user when in use. The terms ‘proximal’ and ‘distal’ as applied to features of the system 100 will be described by reference to the relative positioning of such features with respect to each other in a proximal-distal direction along a longitudinal axis.

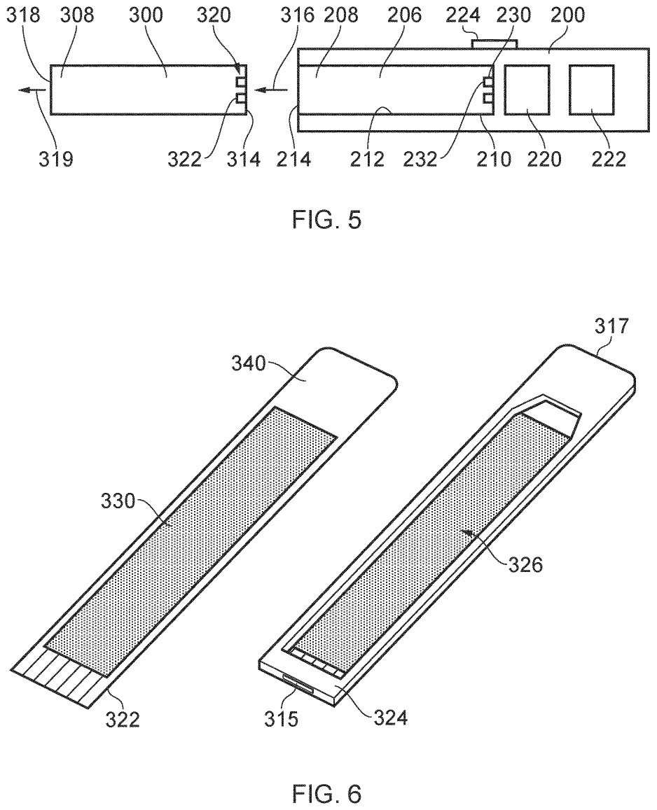

The article 300 is received by the aerosol provision device 200. The configuration of the article 300 and the aerosol provision device 200 may vary. In the present embodiment, the aerosol provision device 200 comprises a device body 202. The device has a housing 204 enclosing components of the device 200. An article receiving portion 206, sometimes referred to as a device chamber, as shown in FIG. 5, is configured to receive a portion of the article 300. A proximal end 308 of the article protrudes from the device 200 when the article 300 is received in the device chamber 206. A receptacle 208 defines the chamber 206. The receptacle 208 comprises a receptacle base 210 and a receptacle peripheral wall 212. The configuration of the receptacle 208 may vary in dependence on the configuration of the article 300.

One or more user-operable control elements 224, such as a button or switch, which can be used to operate the aerosol provision system 100 may be provided on the aerosol provision device 200. For example, a user may activate the system 100 by pressing the control element 224.

The aerosol provision device 200 comprises an opening 214 at the proximal end, leading into the device chamber 206. The opening 214 is provided in one end, through which the article 300 can be inserted. In embodiments, the article 300 may be fully or partially inserted into the device 200. The configuration of the device 200 may vary, for example the opening may be in a longitudinal side wall of the device 200, and/or may be closed by another feature of the device 200 during use. In the present configuration, the article 300 defines a mouthpiece 310 at the proximal end 308. In other embodiments, the device 200 defines the mouthpiece. The user places their mouth over the mouthpiece during use.

The device 200 defines the longitudinal axis along which an article 300 may extend when inserted into the device 200. The opening 214 is aligned on the longitudinal axis. The longitudinal axis may be an axis along which the article 300 is inserted into the device 200. The longitudinal axis may be considered to be a receiving axis of the device 200. The article 300 may similarly have a longitudinal axis along which it is inserted into the device and this axis may be considered to be an insertion axis.

The aerosol provision device 200 comprises a power source 220. The power source 220 may be a battery, for example a rechargeable battery. The device 200 also comprises a control circuit 222, acting as a controller, comprising a processor and a memory.

As discussed in detail below, a heating system 110 is configured to heat the aerosol generating material 302 of an article 300. The article 300 in embodiments is a consumable, and is interchangeable with other articles 300. The heating system 110 comprises the aerosol generator 304. The heating system 110 comprises other components of the aerosol provision system 100 including components of the article 300 and the aerosol provision device 200, for example the power source 220 and the control circuit 222.

The aerosol generator 304 forms part of the article 300. The aerosol generator 304 comprises a heating arrangement 312 configured to heat aerosol generating material 302, for example at least one of a film and a gel to generate an aerosol. The aerosol generating material may be referred to as aerosolisable material.

The heating arrangement 312 is a resistive heating arrangement. The or each heating element in embodiments is a resistive heating element, as described in detail below. In such arrangements the heating system 110 comprises a resistive heating generator including components to heat the heating arrangement 312 via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement 312 comprises electrical contacts for supplying electrical current to the resistive material. The provision of a resistive heating arrangement 312 allows for a compact arrangement. Resistive heating provides an efficient configuration.

In the use of the aerosol provision system 100, air is drawn into an air inlet 314 of the article 300, as indicated by arrow 316. The air inlet 314 is in a distal end of the article 300. In embodiments, the air inlet 314 may have a different configuration, for example in the side. The air flow to the air inlet 314 of the article 300 may be defined, for example by at least one of an air path through the device 200, an air path external to the device 200, and an air path between the device 200 and the article 300. An aerosol generated by the aerosol generator 304 exits the device at an aerosol outlet 318, as indicated by arrow 319. In embodiments the aerosol outlet 318 is in the mouthpiece of the article 300, such that the aerosol is drawn directly from the article 300 into the mouth of a user of the device 10.

In some example embodiments, the aerosol provision system comprises two main components, namely a control section forming a reusable part and a consumable section forming a replaceable or disposable part which may be referred to as a replaceable or disposable article or cartridge. As described herein, the aerosol provision device 200 forms a control section and the article 300 forms the consumable section. In the use of the aerosol generating system, the control section and the consumable part may be releasably connected at an interface. The consumable part may be removable and replaceable, for example when the consumable part is used, with the control section being re-used with a different consumable part.

The aerosol provision system 100 as shown is provided by way of example only and is highly schematic. Different aerosol generating devices and other devices may be used in example implementations of the principles described here. For example, in some example embodiments, air is drawn into an air inlet in the control section, passes through the interface, and exits the consumable part.

As shown schematically in FIG. 5, and described in detail below, the article 300 has an article electrical contact configuration 320. The electrical contact configuration 320 in embodiments is formed by the aerosol generator 304. The electrical contact configuration 320 comprises heater electrical contacts 322. The heater electrical contacts 322 may also be known as heater or article contacts. The aerosol provision device 200 comprises an electrical connector 230. The electrical connector 230 comprises connector electrical contacts 232. The connector electrical contacts 232 may also be known as connector or device contacts. The article electrical contact configuration 320 is configured to electrically communicate with the device electrical connector 230.

The configuration of the article 300 may vary. The article 300 comprises a body 324. The body 324 is hollow. The body 324 defines a flow path 326 (refer to FIG. 6) through the article 300. The flow path 326 extends between the air inlet 314 and the aerosol outlet 318. The flow path 326 is defined by an internal space in the article along which air and/or aerosol can flow. The flow path 326 is defined in the body 324. The or each aerosol generator 304 bounds the flow path 326. The aerosol generating material 302 is exposed to the flow path 326. The aerosol generating material 302 is exposed in the internal space. The internal space in embodiments comprises two or more chambers.

The air inlet 314 comprises an opening 315. The opening 315 is formed in the body 324. In embodiments, the opening is formed in another component of the article 300, for example the aerosol generator 304 or another wall feature. The aerosol outlet 318 comprises an outlet opening 317. The outlet opening 317 is formed in the body 324. In embodiments, the outlet opening 317 is formed in another component of the article 300, for example the aerosol generator 304 or another wall feature.

As shown in FIG. 6, the article 300 comprises two aerosol generators 304 forming an aerosol generator arrangement. The number of aerosol generators 304 may differ. Each aerosol generator 304 comprises aerosol generating material 302. The aerosol generating material 302 is exposed to the flow path 326. In embodiments the article 300 comprises a single aerosol generator 304. One of the aerosol generators 304 will be described in detail, with such detail being applicable to one or more further aerosol generators 304 in embodiments.

The or each aerosol generator 304 and the body 324 are formed in a stacked configuration. In embodiments, other arrangements such as a tubular arrangement of the article are envisaged. In such tubular arrangements the aerosol generator 304 defines a tubular configuration. Tubular may include circular cross-sectional, an elliptical cross section and other polygonal shapes.

In embodiments, as shown in the Figures, the article 300 has a flat configuration. That is, wherein an exterior of the article has a length, a width perpendicular to the length, and a depth perpendicular to each of the length and the width, wherein the length is greater than or equal to the width, and wherein the width is greater than the depth. Other configurations are envisaged.

FIG. 6 is a partially exploded perspective view of the article 300, with an aerosol generator 304 shown inverted from an assembled orientation and in a spaced relationship with other components. The article 300 comprises a first one of the aerosol generator 302, the body 324 and a second one of the aerosol generator. The body 324 spaces the first and second aerosol generators 304. The first and second aerosol generators 304 close the internal space defined by the body 324 along which air and/or aerosol can flow. The aerosol generating material 302 of the first and second aerosol generators 304 face each other and is exposed to the internal space. When assembled, the first and second aerosol generators 304 sandwich the body 324. In the embodiment of FIG. 6 at least, the first and second aerosol generators 304 and the body have equal plan areas. In embodiments, one or more of the first and second aerosol generators 304 and the body 324 has a greater length and/or width. In embodiments, one of the first and second aerosol generators 304 is replaced by a blank panel. The body 324 comprises a body layer. The body may comprise a plurality of body layers. The body layers may be formed in a stack and arranged to define features of the article 300, such as the air inlet 314 and aerosol outlet 318.

A wrap encircles the article 300 and forms part of the article 300. The wrap may comprise a sheet. The wrap acts as a fixed sleeve. The or each aerosol generator 304 protrudes from the wrap at a distal end. Exposed electrical contact regions 323 of the heater contacts 322 are exposed at the distal end. Other configurations are envisaged, for example at least one exposed electrical contact region 323 may additionally or alternatively be defined along a minor longitudinal face or edge of the article 300, and on a major face of the article defined by the aerosol generator 304.

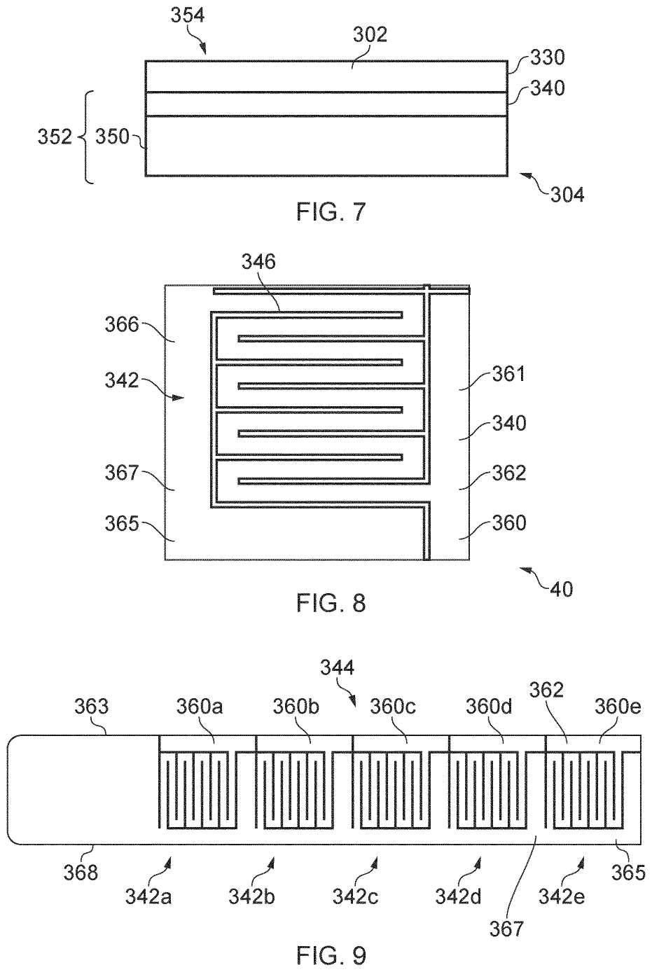

The aerosol generator 304 is schematically shown in cross section in FIG. 7. The aerosol generator 304 is an implementation of the aerosol generator 304 of the aerosol provision system 100 described above.

The aerosol generator 304 comprises an aerosol generating layer 330. The aerosol generating layer is also known as an aerosolisable layer. The aerosol generating layer 330 comprises the aerosol generating material 302. The aerosol generator 304 comprises a resistive heating layer 340. The resistive heating layer 340, in embodiments, is formed as an electrically conductive layer. The aerosol generating layer 330 is on the resistive heating layer 340. The aerosol generating layer 330 is in direct contact with the resistive heating layer 340. In embodiments, the aerosol generating layer 330 is in indirect contact with the resistive heating layer 340. The resistive heating layer 340 may in embodiments comprise a coating. As described in detail below, the resistive heating layer 340 comprises a plurality of resistive heating elements 342, for example as shown in FIGS. 8 and 9. The or each resistive heating element 342 forms at least a portion of an electrically conductive path between a pair of the electrical contacts 322. The or each resistive heating element 342 provides the electrically conductive path for resistive heating of at least of portion of the aerosol generating material 302 to generate an aerosol. The aerosol generating material 302 is, in embodiments, in the form of a film or a gel.

The resistive heating layer 340 is formed as an electrically conductive layer. This layer in embodiments takes the form of at least one of a metal layer, such as an aluminium layer, or a non-metallic material, such as graphene. The resistive heating layer 340 is in the form of a foil, for example an aluminium foil.

The aerosol generator 304 comprises a support 350. The support 350 in embodiments comprise a paper or card material. The support 350 provides structural support for the aerosol generator 304. The resistive heating layer 340 is on the support 350. The support 350 is configured as a support layer. As shown in FIG. 7, in the aerosol generator 304, the resistive heating layer 340 is sandwiched between the support 350 and the aerosol generating layer 330.

The support 350 is electrically insulative. The resistive heating layer 340 and the support layer 350 define a substrate 352. The substrate 352 supports the aerosol generating layer 330.

The article 300 may comprise a laminate 354 comprising the resistive heating layer 340 and the support layer 350. In embodiments, the laminate 354 comprises the aerosol generating layer 330. The aerosol generating layer 330 may be formed as a contiguous configuration, or may be formed from discrete portions. The discrete portions may comprise one or more of dots, strips, spirals, or other shapes.

One or more of the aerosol generating layer 330, resistive heating layer 340 and the support layer 350 may comprise a further layer. For example the support layer 350 may comprise a backing layer or an intermediate layer. The support layer 350 in embodiments is omitted.

FIG. 8 shows one of the resistive heating elements 342. The resistive heating layer 340 comprises a plurality of resistive heating elements 342. In embodiments, the resistive heating layer 340 comprises a single resistive heating element 342.

The plurality of heating elements 342 may be formed in an array 344 as shown in FIG. 9. Other configurations are envisaged.

The resistive heating element 342 comprises a resistive heating path. The resistive heating path is formed by an electrically conducting path. The resistive heating path is non-straight. The resistive heating path is convoluted. The configuration of the resistive heating path may vary. The electrical resistance of the heating element 342 may be dependent on the nature of the resistive heating path in the conductive layer, for example the length, width, thickness and arrangement of the path.

The resistive heating element 342 extends between a first type of electrical contact 360 and a second type of electrical contact 365. The first type of electrical contact 360 is configured to provide a positive contact and the second type of electrical contact 365 is configured to provide a negative contact. Electrical current flows between the first type of electrical contact 360 and the second type of electrical contact 365 through the path. The contact arrangement may be reversed. The first and second types of electrical contacts 360, 365 are heater electrical contacts 322. The first and second types of electrical contacts 360, 365 form at least part of the article electrical contact configuration 320.

The meandering or serpentine nature of the path of the resistive heating element 342 is such that the electrical resistance of the path is increased when compared with a straight path between the first and second type of electrical contacts.

The resistive heating layer 340 may comprise a first type of electrical track 361 extending from the resistive heating element 342. The first type of electrical track 361 comprises the first type of electrical contact 360. The electrical contact 360 of the first type is configured to electrically connect with the device electrical connector 230. The first type of electrical contact 360 comprises a first type of exposed contact region 362. The first type of exposed contact region 362 is exposed on the article for direct connection with the device electrical connector 230.

The resistive heating layer 340 may comprise a second type of electrical track 366 extending from the resistive heating element 342. The second type of electrical track 366 comprises the second type of electrical contact 365. The electrical contact 365 of the second type is configured to electrically connect with the device electrical connector 230. The second type of electrical contact 365 comprises a second type of exposed contact region 367. The second type of exposed contact region 367 is exposed on the article 300 for direct connection with the device electrical connector 230.

As discussed in detail below, the conducting path of the resistive heating element 342 in embodiments is created by defining at least one electrically insulative barrier 346 in the resistive heating layer 340. In embodiments, the electrically insulative barrier 346 is formed by cutting electrically insulative barrier restrictions (i.e. electrically insulating portions), such as gaps, channels or slots into a sheet formed of electrically conductive material to form the resistive heating layer 340. In embodiments, the electrically conductive element 342 is preformed to define the or each resistive heating element 342 and then applied to the support 350. In embodiments, the resistive heating layer 340 is applied to the support 350, and the or each resistive heating element 342 then defined in the resistive heating layer 340. The or each restive heating element 342 defining the resistive heating layer 340 may be a printed heater.

The at least one electrically insulative barrier 346 defines the first and second types of electrical track 361, 366.

In some embodiments, the tracks of the or each resistive heating element 342 have a width in the region of 0.5 mm to 1 mm (two example prototypes have widths of 0.93 mm and 0.72 mm respectively) and gaps between the tracks of less than about 0.25 mm (the same two example prototypes have gaps of 0.2 mm and 0.05 mm respectively). The or each resistive heating element 342 may have overall dimensions of the order of 10 mm×10 mm. Other dimensions are possible in other example embodiments. By forming the or each resistive heating element 342 of these dimensions from an aluminium foil of having a thickness of 0.006 mm and an electrical resistivity of between 2 and 6 μOhmcm, the resistance of the path has been calculated to be of the order of 1 Ohm. In one example embodiment, the resistance was measured at between 0.83 and 1.31 Ohms.

As shown in FIG. 9, the resistive heating layer 340 may be formed into a plurality of resistive heating elements, indicated generally by the reference numerals 342a, 342b, 242c, 342d and 342e. Each of the resistive heating elements 342a-342e extends from a respective one of the first type of electrical contact, indicated generally by the reference numerals 360a, 360b, 360c, 360d and 360e to a single second type of electrical contact 365. The number of electrical contacts may vary. As such, each resistive heating element 342a-342e extends between a discrete first type of electrical contact and a common second type of electrical contact.

Each of the resistive heating element 342a-342e provides an electrically conductive path for resistive heating of a portion of the aerosol generating material 302 to generate an aerosol at the respective portion of the aerosol generator 304.

The separate first type 360a-360e of electrical contacts enable an electric current to be individually provided to each of the plurality of resistive heating elements 342a-342e. The heating of different zones of the aerosol generating layer 330 can be controlled. For example, an aerosol generator may be provided with five aerosol generating zones. The resistive heating layer 340 allows each of those zones to be activated separately. Accordingly, for example, five puffs of aerosol may be generated from a single consumable incorporating a single aerosol generator 304, and ten puffs of aerosol may be generated from a single consumable incorporating two aerosol generators 304.

In the example resistive heating layer 340, the plurality of first type of electrical contacts 360a-360e, for example a positive electrical connection, are provided and a single second type of electrical contact 365, for example a negative electrical connection is provided. This is not essential to all implementations. For example, multiple contacts of the second type could be provided. In embodiments each resistive heating element 342a-342e comprises a corresponding one of the first type of electrical contact 360 and a corresponding one of the second type of electrical contact 365.

In the shown embodiment of FIG. 9 of the resistive heating layer 340, the first type of electrical contacts 360a-360e are arranged on a first edge 363 of the resistive heating layer 340 and the second type of electrical contact 365 is arranged on a second edge 368 of the resistive heating layer 340. This may allow for convenient connection of electrical power, but, of course, many other configurations are possible, some of which are discussed further below.

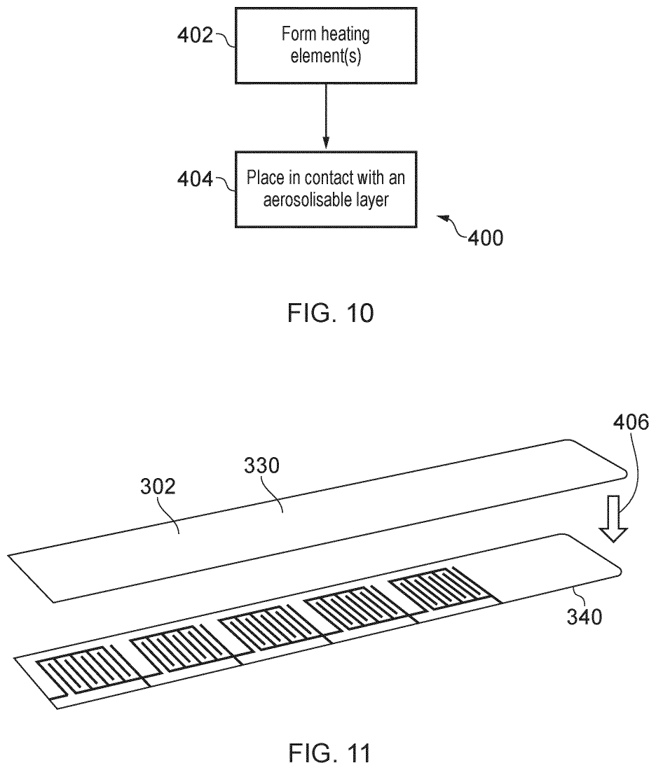

FIG. 10 is a flow chart showing part of a method of forming an aerosol generator 304 or an algorithm, indicated generally by the reference numeral 400, in accordance with an example embodiment.

The method or algorithm 400 starts at operation 402, where a resistive heating layer is formed into one or more heating elements (e.g. a plurality of heating elements), wherein each resistive heating element extends from an electrical contact of a first type to an electrical contact of a second type. In use, the or each heating element may be used to provide an electrically conductive path for resistive heating of a portion of an aerosol generating material to generate an aerosol. The formation of the or each resistive heating element may occur prior to or post application of the resistive heating layer on a support, where a support is present. The resistive heating layer may be adhered to the support, or mounted or formed on the support in a different configuration.

At operation 404, the formed the resistive heating layer is placed in contact with the aerosol generating layer, wherein said aerosol generating layer incorporates aerosol generating material. Algorithm 400 may be used to produce the aerosol generator 304 described above.

FIG. 11 shows the aerosol generator 304 being formed in accordance with an embodiment. The aerosol generating material 302 is formed on the resistive heating layer 340 by depositing aerosol generating material, for example by spraying, painting, dispensing or in some other way. The aerosol generating layer 330 is disposed on resistive heating layer 340 as indicated by the arrow 406, in an example implementation of the operation 64.

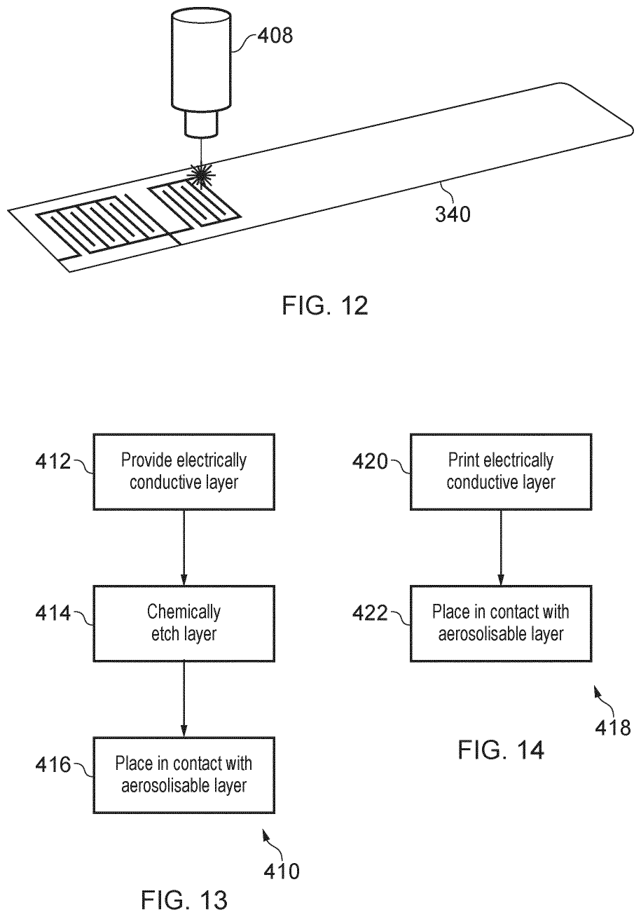

FIG. 12 shows the resistive heating layer 340 being formed in accordance with an example embodiment. The resistive heating layer 340 is in the process of being cut using a laser cutter 408. The cutting of the resistive heating layer 340 can be used to form the paths of the heating elements described herein. The use of the laser cutter 408 (or some other cutting process) is not the only method by which the resistive heating layer 340 described herein may be generated. Some example methods are described below.

FIG. 13 is a flow chart showing part of a method of forming an aerosol generator 304 or an algorithm, indicated generally by the reference numeral 410. The method or algorithm 410 starts at operation 412, where the resistive heating layer is provided. At operation 414, one or more of the resistive heating elements are formed in the resistive heating layer by chemically etching the resistive heating layer. The operations 412 and 414 are an example implementation of the operation 402 of the method 400 described above. The aerosol generating material is then disposed on the resistive heating layer, thereby implementing the operation 404 described above.

FIG. 14 is a flow chart showing part of a method of forming an aerosol generator 304 or an algorithm, indicated generally by the reference numeral 418. The method or algorithm 418 starts at operation 420, where one or more heating elements are formed, at least in part, by printing a resistive heating layer. The operation 420 is therefore an example implementation of the operation 62 of the algorithm 402 described above. The aerosol generating material is then disposed on the resistive heating layer, thereby implementing the operation 404 described above.

The cutting, etching and printing methods described above are provided by way of example; other additional or alternative methods are also possible. For example, a so-called “hot foiling” approach could be used in which a heating element is made out of a resistive heating layer, and then assembled/bonded onto a support. Yet other techniques could be used, such as die cutting. Moreover, two or more technologies could be combined (e.g. electrical conductivity could be added to connection traces by adding more conductive material, such as additional foil, printed material, etc.). The skilled person will be aware of many further technologies, or combinations of technologies, that could be used in implementations of the principles described herein.

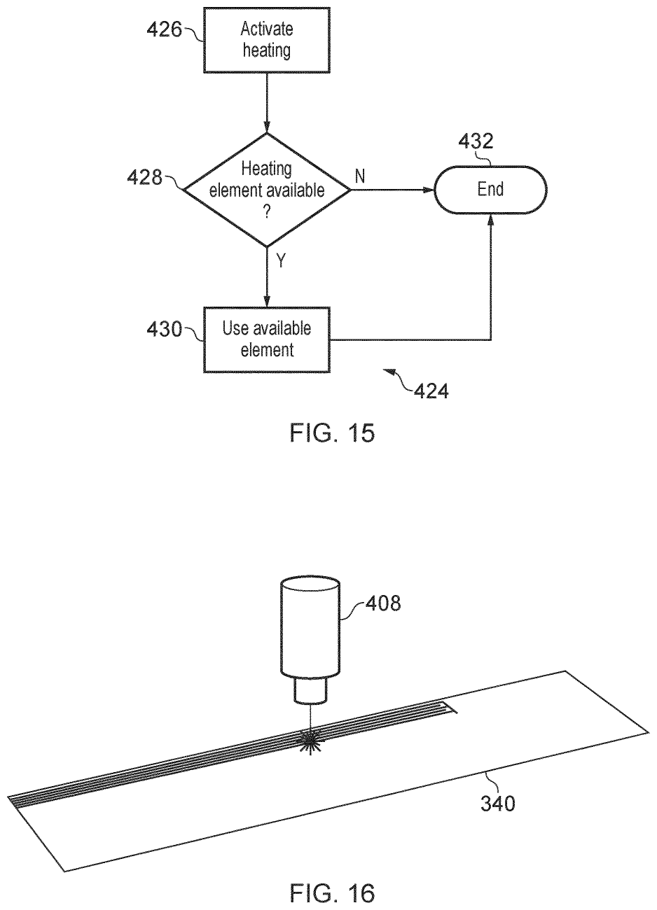

FIG. 15 is a flow chart showing method of operation or an algorithm, indicated generally by the reference numeral 424, in accordance with an example embodiment. The method or algorithm 424 may, for example, be implemented using any of the aerosol generators described herein. The method or algorithm 424 is initiated when an instruction to activate heating is received in an instance of operation 426. In response to the instruction to activate heating, a determination is made (in operation 428) regarding whether a heating element is available. As discussed above, a plurality of heating elements may be provided. The operation 428 may involve determination which of the heating elements have been used and/or the corresponding available aerosol generating material used up.

If a heating element is available, the algorithm moves to operation 430, where an available heating element is used. As discussed above, heating elements may be individually controllable, for example by providing electrical power to individual heating elements. Once the operation 430 is complete, the algorithm terminates at operation 432. If, at operation 428, a determination is made that no heating elements are available, for example because all heating elements have been used, then the algorithm terminates at operation 432. This may mean that a consumable part being used to implement the algorithm 424 needs to be replaced.

FIG. 16 shows the resistive heating layer 340 being formed in accordance with an embodiment. The resistive heating layer 340 is being cut using the laser cutter 408, although other methods could be used, such as chemical etching or printing, as discussed above. The cutting of the electrically conductive layer 340 forms the heating elements as described herein.

In the embodiment of FIG. 16, the paths cut are linear paths, extending along the length of the electrically conductive layer 120.

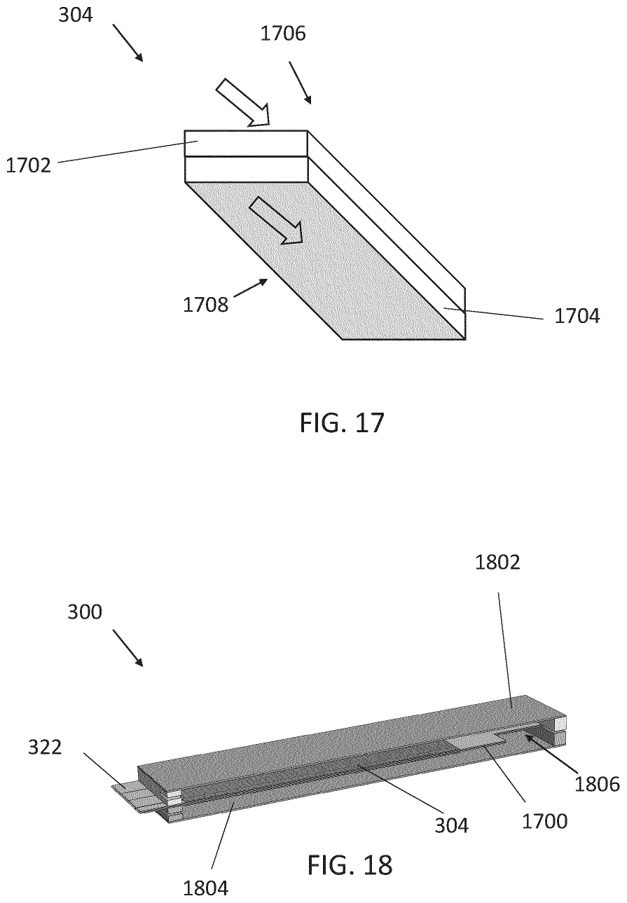

FIG. 17 shows a schematic illustration of another embodiment of an aerosol generator 304. In this embodiment, the aerosol generator 304 comprises a first resistive heating layer 1702 and a second resistive heating layer 1704. The first and/or second resistive heating layer 1702, 1704 may be the same or have one or more features the same as any of the above-described resistive heating layers 340. In this embodiment, the first and second resistive heating layers 1702, 1704 are arranged to be back-to-back so that the resistive heating elements 342 are exposed on the external surfaces. In other words, the resistive heating elements 342 faces outwards from the external surfaces of the aerosol generator 304. The resistive heating elements 342 can be considered to be facing away from each other. The aerosol generator 304 further comprises a first aerosol generating layer (not shown) disposed on the resistive heating element 342 of the first resistive heating layer so that the first aerosol generating layer can be heated by the resistive heating element 342 of the first resistive heating layer 1702. As such, the first aerosol generating layer is also disposed on an external surface of the aerosol generator 304. The aerosol generator 304 comprises a second aerosol generating layer (not shown) disposed on the resistive heating element 342 of the second resistive heating layer 1704 so that the second aerosol generating layer can be heated by the resistive heating element 342 of the second resistive heating layer 1704. As such, the second aerosol generating layer is also disposed on an external surface of the aerosol generator 304

In this embodiment, the first resistive heating layer 1702 at least partially defines a first airflow path 1706. The first airflow path 1706 is coupled to an outlet (not shown) from which a user may inhale air that is inside the first airflow path. Aerosol generated from the first aerosol generating layer tend to be dispersed into the first airflow path 1706. Airflow within the first airflow path 1706 may carry the dispersed aerosol to the outlet and/or mouth end for inhalation by a user.

In this embodiment, the second resistive heating layer 1704 at least partially defines a second airflow path 1708. The second airflow path 1708 is coupled to an outlet (not shown) from which a user may inhale air that is inside the second airflow path. Aerosol generated from the second aerosol generating layer tends to be dispersed into the second airflow path 1708. Airflow within the second airflow path 1708 may carry the dispersed aerosol to the outlet and/or the mouth end for inhalation by a user.

Advantageously, the above-described construction allows for the amount of aerosol stored by the aerosol generator to be increased without significantly increasing the size of the aerosol generator.

FIG. 18 shows a cut away view of an aerosol forming article 300 comprising the aerosol generator 304. The article 300 comprises the aerosol generator 304 and a cover. The cover comprises a first portion 1802 and a second portion 1804. The first portion 1802 is positioned spaced apart from the first resistive heating layer of the aerosol generator 304. The first portion 1802 together with the first resistive heating layer 1702 defines the first airflow path therebetween. The second portion 1804 is positioned spaced apart from the second resistive heating layer of the aerosol generator 304. The second portion 1804 together with the second resistive heating layer 1704 defines the second airflow path therebetween. The second portion 1804 defines the second airflow path therebetween.

An electrical contact portion of the aerosol generator 304 extends beyond the cover and/or the first and second portions 1802, 1804. The heater electrical contacts 322 are exposed for electrical connection with a power source 220 of an aerosol provision device 200. The power source 220 and/or aerosol provision device 200 have been described above. The heater electrical contacts 322 comprises first and second types of electrical contacts from the first resistive heating layer on a first side. The heater electrical contacts 322 comprises first and second types of electrical contacts from the second resistive heating layer on a second side opposite to the first side. In this embodiment, there is a plurality of the first type of electrical contacts. In other embodiments, there is not a plurality of the first type of electrical contacts, e.g. there is only one first type of electrical contact. In this embodiment, the first type of electrical contact is common to both the first and second resistive heating layers. In other embodiments, the first type of electrical contact is not common to both the first and second resistive heating layers, e.g. each of the first and second resistive heating layers connect to a respective first type of electrical contact.

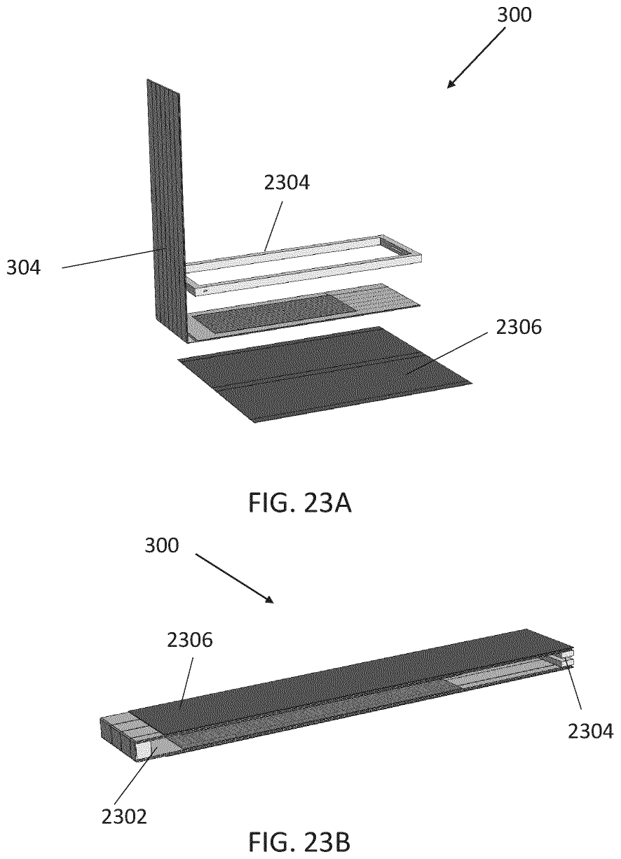

The article 300 further comprises an aperture 1806. The aperture 1806 fluidly connects the first airflow path to the second airflow path. The aperture 1806 is formed from a cut away from the aerosol generator 304. In some embodiments, the cut away from the aerosol generator 304 and the cover combine to form the aperture 1806. In some embodiments, the cut away from the aerosol generator 304 and the cores (which may be one or more cores) combine to form the airflow outlet for the article. The cores are omitted from FIG. 18 but are described in more detail below, e.g. in relation to FIGS. 23 to 25. In some embodiments, the article 300 comprises two or more apertures. Advantageously, the aperture allows the use on a single outlet for both airflow paths thereby simplifying manufacture of the article.

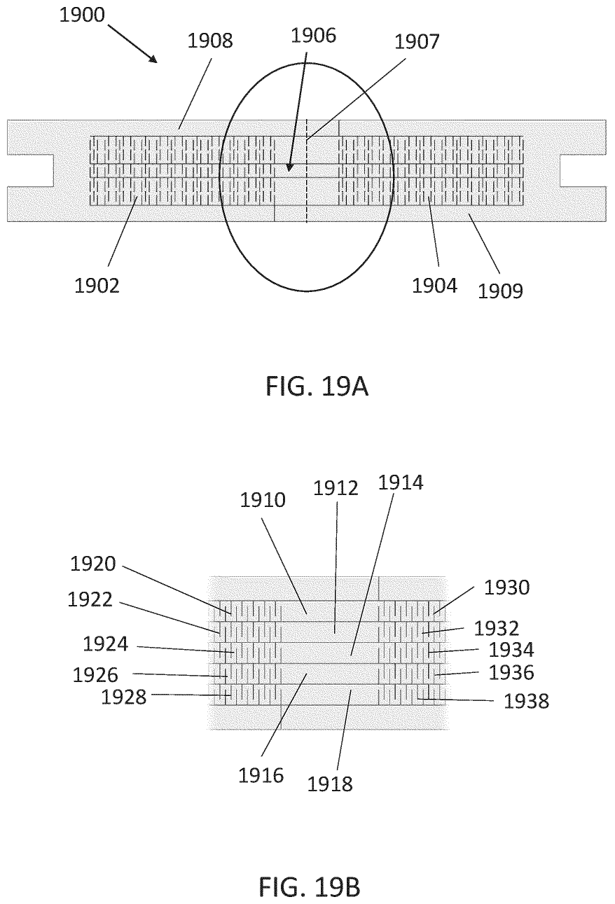

The aerosol generator 304 described above may be formed from a blank 1900 as shown in FIG. 19A. The blank 1900 is a single sheet of conductive material. The blank 1900 comprises a first region 1902, a second region 1904, a third region 1906, a fourth region 1908, and a fifth region 1909. The aforementioned regions are all formed on a single sheet of conductive material. In this embodiment, the single sheet of conductive material is aluminium backed card, i.e. a sheet of card having a layer of aluminium deposited thereon. The aforementioned regions are all formed on the same side of the single sheet of conductive material. In some embodiments, the blank 1900 comprises a support 350 on which the single sheet of conductive material is deposited. The card material discussed in the embodiment of FIG. 19A may be considered to be a support 350. In other embodiments, the sheet of conductive material may comprise the support 350.

The first region 1902 corresponds to the first resistive heating layer as described above. In other words, the first region 1902 is formed to have the same features of the first resistive heater layer. The first region 1902 may be formed by etching chemically or by a laser or by printing conductive material onto a substrate. In some embodiments, the first region 1902 may be formed by cutting such as die cutting. The substrate may be the aerosol generating material or a sheet of card material.

The second region 1904 corresponds to the second resistive heating layer as described above. In other words, the second region 1904 is formed to have the same features of the second resistive heater layer. The second region 1904 may be formed by etching chemically or by a laser or by printing conductive material onto a substrate. In some embodiments, the second region 1904 may be formed by cutting such as die cutting. The substrate may be the aerosol generating material or a sheet of card material.

The third region 1906 corresponds to a plurality of a first type of the electrical contacts. The plurality of first type of the electrical contacts may be common to both the first and second resistive heating layer. In this embodiment, a respective resistive heating element in the first resistive heating layer extends from one end of one of the plurality of the first type of electrical contacts and a respective resistive heating element in the second resistive layer extends from the other end of the aforementioned first type of electrical contact. In other words, each of the first type of electrical contact has two resistive heating elements extending therefrom, each corresponding to a respective resistive heating layer. In other embodiments, the first type of electrical contact from the first resistive heating layer is separate from the first type of electrical contacts from the second resistive heating layer. The third region 1906 comprises a fold line 1907. In this embodiment, the fold line 1907 is positioned in the centre of the third region 1906 between the first and second regions 1902, 1904. In other embodiments, the fold line is not positioned in the centre of the third region between the first and second regions, e.g. the fold line may be positioned anywhere between the first and second regions.

Folding of the blank 1900 about the fold line 1907 may be part of the manufacturing process of producing the aerosol generator 304 of FIG. 17 and/or the article 300 of FIG. 18. In these embodiments, the aerosol generator has resistive heating layers that are arranged to be back to back with each other. In this arrangement, the support 350 of each resistive heating layers may abut or contact each other. The resistive heating elements of each of the resistive heating layers may face away from each other in opposite directions. In these embodiments, the support 150 advantageously mitigates or eliminates any weakness caused by the folding. Moreover, the support 150 tends to ensure that the resistive heating elements on opposing sides of the aerosol generator 304 are isolated/remote from each other. In some embodiments, the support 150 can be omitted entirely.

Referring now to FIG. 19B, which shows a close up of the portion circled in FIG. 19A. The plurality of first type of electrical contacts comprises a first electrical contact 1910, a second electrical contact 1912, a third electrical contact 1914, a fourth electrical contact 1916, and a fifth electrical contact 1918. In this embodiment, each of the first type of electrical contacts is elongate along the longitudinal direction. In other embodiments, each of the first type of electrical contacts is not elongate along the longitudinal direction, e.g. each of the first type of electrical contacts may have a shape that is not elongate. In other embodiments, each of the aforementioned electrical contacts are cut/separated into two portions, each portions extends to a respective resistive heating layer.

The first resistive heating layer and/or the first portion comprises a first resistive heating element 1920, a second resistive heating element 1922, a third resistive heating element 1924, a fourth resistive heating element 1926, and a fifth resistive heating element 1928.

The second resistive heating layer and/or second portion comprises a sixth resistive heating element 1930, a seventh resistive heating element 1932, an eighth resistive heating element 1934, a ninth resistive heating element 1936, and a tenth resistive heating element 1938.

The first resistive heating element 1920 extends from one longitudinal end of the first electrical contact 1910. The sixth resistive heating 1930 element extends from the other longitudinal end of the first electrical contact 1910.

The second resistive heating element 1922 extends from one longitudinal end of the second electrical contact 1912. The seventh resistive heating 1932 element extends from the other longitudinal end of the second electrical contact 1912.

The third resistive heating element 1924 extends from one longitudinal end of the third electrical contact 1914. The eighth resistive heating 1934 element extends from the other longitudinal end of the third electrical contact 1914.

The fourth resistive heating element 1926 extends from one longitudinal end of the fourth electrical contact 1916. The ninth resistive heating 1936 element extends from the other longitudinal end of the fourth electrical contact 1916.

The fifth resistive heating element 1928 extends from one longitudinal end of the fifth electrical contact 1918. The tenth resistive heating 1938 element extends from the other longitudinal end of the fifth electrical contact 1928.

Referring now to FIG. 19A, the fourth region 1908 corresponds to a second type of electrical contact of the first resistive heating layer. This second type of electrical contact is common to each of resistive heating elements of the first resistive heating layer. In other words, each of the resistive heating elements in the first resistive heating layer extends to the second type of electrical corresponding to the fourth region 1908.

The fifth region 1909 corresponds to a second type of electrical contact of the second resistive heating layer. This second type of electrical contact is common to each of resistive heating elements of the second resistive heating layer. In other words, each of the resistive heating elements in the second resistive heating layer extends to the second type of electrical corresponding to the fifth region 1909. The fourth region 1908 is electrically separated from the fifth region 1909.

Advantageously, the above described arrangement allows for an increase in the number of heating zones (corresponding to a resistive heating element) provided while reducing and/or minimizing the number of electrical contacts. For example, this may be due to the first and second resistive heating layers sharing the first type of electrical contacts. Similarly, the resistive heating elements of each resistive heating layer also share a second type of electrical contact. Moreover, the capability for individual activation is not sacrificed to achieve this advantage. Specifically, power can be selectively supplied to a particular first type of electrical contact and a particular second type of electrical contact. This ensures that power can only flow through one of the resistive heating elements.

Furthermore, such an arrangement allows for rotational symmetry along the longitudinal axis of the article thereby reducing the complexity.

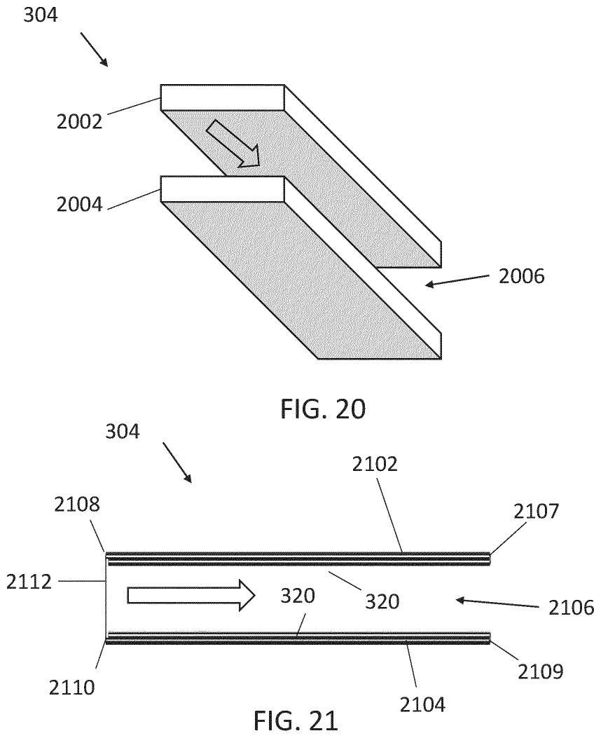

FIG. 20 is a schematic illustration of another embodiment of an aerosol generator 304. In this embodiment, the aerosol generator 304 comprises a first resistive heating layer 2002 and a second resistive heating layer 2004. The first and/or second resistive heating layer 2002, 2004 may be the same or have one or more features the same as any of the above-described resistive heating layers 340. In this embodiment, the first and second resistive heating layers 2002, 2004 are arranged to be spaced apart from each other. The first and second resistive heating layers 2002, 2004 are arranged to be facing each other. In other words, the resistive heating elements 342 face inwards (i.e. towards a central region of the article 300). The aerosol generator 304 further comprises a first aerosol generating layer (not shown) disposed on the resistive heating element 342 of the first resistive heating layer 2002 so that the first aerosol generating layer can be heated by the resistive heating element 342 of the first resistive heating layer 2002. As such, the first aerosol generating layer is also disposed on an internal surface of the aerosol generator 304. The aerosol generator 304 comprises second aerosol generating layer (not shown) disposed on the resistive heating element 342 of the second resistive heating layer 2004 so that the second aerosol generating layer can be heated by the resistive heating element 342 of the second resistive heating layer 2004. As such, the second aerosol generating layer is also disposed on an internal surface of the aerosol generator 304.

In this embodiment, the first resistive heating layer 2002 together with the second resistive heating 2004 at least partially defines an airflow path 2006 therebetween. One or both of the first and second aerosol generating layers may release/disperse aerosol into the airflow path 2006. Airflow within the airflow path 2006 may carry the dispersed aerosol to the outlet and/or mouth end for inhalation by a user.

Advantageously, the above-described construction allows for the amount of aerosol stored by the aerosol generator to be increased without significantly increasing the size of the aerosol generator.

FIG. 21 shows a cross-sectional view of another embodiment of an aerosol generator 304. The aerosol generator 304 has all the features of the aerosol generator shown in FIG. 20. The aerosol generator 304, in addition to the first and second resistive heating layers 2102, 2104 and the airflow path 2106, comprises a first fold 2108, a second fold 2110, a connecting portion 2112. In this embodiment, the first and second resistive heating layers 2102, 2104 and the connecting portion 2112 are formed from a single sheet of material. The single sheet of material may be aluminium backed card, i.e. a sheet of card having an aluminium foil deposited thereon. The single sheet of material is folded at the first fold 2108 and the second fold 2110 to form the connecting portion 2112. The first fold 2108 extends along a lateral direction perpendicular to the longitudinal direction. The second fold 2110 also extends along the lateral direction. The size of the connection portion 2112 defines the size of the gap between the first and second resistive heating layers 2102, 2104. As such, the size of the connecting portion 2112 also defines the size of the airflow path 2106. The connecting portion 2112 comprises an inlet (not shown) to the airflow path 2106.

The aerosol generator 304 further comprises a third fold 2107 and a fourth 2109 positioned at the distal end of the aerosol generator 304. The third fold 2107 extends along the lateral direction. In this embodiment, the first resistive heating layer 2102 is folded to form the third fold 2107 so that the first resistive heating layer 2102 is arranged to be positioned on the internal surface of the aerosol generator 304. The fourth fold 2109 extends along the lateral direction. In this embodiment, the second resistive heating layer 2104 is folded to form the fourth fold 2109 so that the second resistive heating layer 2104 is arranged to be positioned on the internal surface of the aerosol generator 304. The third and fourth folds 2107, 2109 are configured such that the first and second resistive heating layers 2102, 2104 face each other.

Similar to the embodiment shown in FIG. 20, a first aerosol generating layer 330 is disposed on the internal surface of the first resistive heating layer 2102. The first aerosol generating layer 330 is adjacent to the airflow path 2106 such that the aerosol generated from the first aerosol generating layer 330 can be dispersed into the airflow path 2106. Again, similar to the embodiment shown in FIG. 20, a second aerosol generating layer 330 is disposed on the internal surface of the second resistive heating layer 2104. The second aerosol generating layer 330 is adjacent to the airflow path 2106 such that the aerosol generated from the second aerosol generating layer 330 can be dispersed into the airflow path 2106.

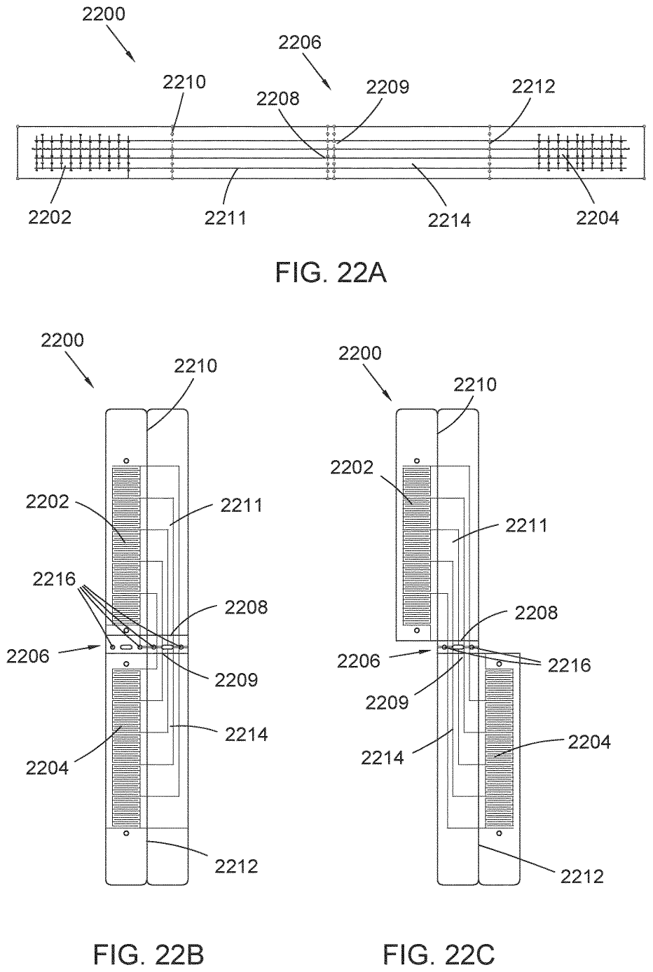

The aerosol generator 304 may be formed using a blank 2200 as shown in FIG. 22A. The blank 2200 may have the one or more features the same as the blank 1900 described in relation to FIG. 19. For example, blank 2200 comprises a first region 2202 corresponding to the first resistive heating layer, a second region 2204 corresponding to the second resistive heating layer, a third region corresponding to a plurality of first type of the electrical contacts, and a fourth region corresponding to second type of electrical contact. Repeated descriptions of the same features are omitted. The blank 2200 further comprises a connecting region 2206 corresponding to the connect portion 2112. The connecting region 2206 comprises a first fold line 2208 and a second fold line 2209. The first and second fold lines 2208, 2209 are spaced apart from each other to form the connection portion therebetween. As such, the distance between the first and second resistive heating layers is determined by the distance between the first and second fold lines 2208, 2209. In some embodiments, the distance between the first and second resistive heating layers may be additionally determined by the combined thickness of first and second regions 2202, 2204 and the first and second external regions 2211, 2214. The first portion 2202 is configured to be folded about the first fold line 2208. The first fold line 2208 extends along a lateral direction perpendicular to the longitudinal direction. The second portion 2204 is configured to be folded about the second fold line 2209. The second fold line 2209 extends along a lateral direction perpendicular to the longitudinal direction. Forming the aerosol generator of FIG. 21 may involve folding the first portion 2202 about the first fold line 2208 and folding the second portion 2204 about the second fold line 2209.

In some embodiments, the connecting region 2206 may comprise one or more alignment features for aligning aerosol generator to a core during manufacture. For example, in the embodiment shown in FIG. 22B, the alignment feature comprises two alignment holes 2216 that would be formed from folding a blank comprising four such holes 2216. In the embodiment shown in FIG. 22C, the alignment feature comprises two alignment holes 2216 formed from two holes 2216 in the blank.

The blank 2200 further comprises a third fold line 2210 and a fourth fold line 2212. The third fold line 2210 is positioned between the first region 2202 and the connection region 2206. Folding about the third fold 2210 allows the resistive heating elements 342 (in the first region) to be positioned on a surface opposite to the connecting region (in the third region) and the first and second type of electrical contacts thereon. This thereby allows the electrical contacts to be positioned on an external surface of the aerosol generator 304 away from the resistive heating elements 342 on the internal surface.

Furthermore, the blank 2200 comprises a first external region 2211 and a second external region 2214. The first external region 2211 is positioned between the first fold line 2208 and the third fold line 2210. The first external region 2211 defines an external surface of the aerosol generator 304. When folding the blank 2200 about the third fold line 2210, the first external region 2211 forms one of the external surfaces of the aerosol generator 304. In some embodiments, each of the first and second type of the electrical contacts extends from the first region 2202 across the first external region 2211 to the connecting region 2206 thereby providing a conductive path from the connecting region 2206 to the resistive heating elements in the first region 2202. In other words, the first external region 2211 comprises a plurality of first conductive tracks. Each of the first conductive tracks is part of a respective conductive path comprising a respective resistive heating element and a respective first type of electrical contact and a respective second type of electrical contact. Each of the first conductive tracks may also be considered to be part of a respective first type of the electrical contacts.

The fourth fold line 2212 is positioned between the second region 2204 and the connection region 2206. Folding about the fourth fold 2212 allows the resistive heating elements 342 (in the second region) to be positioned on a surface opposite to the connecting region (in the third region) and the first and second type of electrical contacts thereon. This thereby allows the electrical contacts to be positioned on an external surface of the aerosol generator 304 and away from the resistive heating elements 342 on the internal surface.

The second external region 2214 is positioned between the second fold line 2209 and the fourth fold line 2212. The second external region 2214 defines another external surface of the aerosol generator 304. When folding the blank 2200 about the fourth fold line 2212, the second external region 2214 forms one of the external surfaces of the aerosol generator 304. In some embodiments, each of the first and second type of the electrical contacts extends from the second region 2204 across the first external region 2212 to the connecting region 2206 thereby providing a conductive path from the connecting region 2206 to the resistive heating elements in the second region 2204. In other words, the second external region 2214 comprises a plurality of second conductive tracks. Each of the second conductive tracks is part of a respective conductive path comprising a respective resistive heating element and a respective first type of electrical contact and a respective second type of electrical contact. Each of the second conductive tracks may also be considered to be part of a respective first type of the electrical contacts. As such, the first and second external regions 2211, 2214 may allow for the positioning the connector electrical contact 232 on the connecting portion of the aerosol generator 304.

In this embodiment, the first external region 2211 is positioned adjacent to the first region 2202 in the longitudinal direction. In other embodiments, the first external region 2211 is not positioned adjacent to the first region 2202 in the longitudinal direction, e.g. the first external region 2211 is positioned adjacent to the first region 2202 in the lateral direction. In this embodiment, the second external region 2214 is positioned adjacent to the second region 2204 in the longitudinal direction. In other embodiments, the second external region 2214 is not positioned adjacent to the second region 2204 in the longitudinal direction, e.g. the second external region 2214 is positioned adjacent to the second region 2204 in the lateral direction.

In some embodiments, such as the embodiment shown in FIG. 22B, both the first and second external regions 2211, 2214 are positioned on the same lateral side as each other. In some embodiments, such as the embodiment shown in FIG. 22C, the first external region 2211 is positioned on a lateral side that is opposite to the lateral side that the second external region 2214 is positioned on. It is noted that the components shown in FIGS. 22B and 22C are the same as those described above in relation to FIG. 22A. As such, repeat description of these features is omitted. However, the embodiments shown in FIGS. 22B and 22C differ from the embodiment of FIG. 22A in that the first and second resistive heating layers do not share the first type of electrical contacts. For each of the embodiments shown in FIGS. 22B and 22C, each resistive heating elements extends between a respective first type of electrical contact and a second type of electrical contact common to a particular resistive heating layer. In other embodiments, the first type of electrical contact can be shared between different resistive heating layer as described above. In some embodiments, such as the embodiment shown in FIG. 22B, the third and fourth fold lines 2210, 2212 may be at least parts of a single fold line.

In some embodiments, such as the one shown in FIG. 22C, the connecting region 2206 is positioned between the first and second external regions 2211, 2214. In some embodiments, such as the one shown in FIG. 22B, the connecting region 2206 is positioned between the first and second external regions 2211, 2214 and positioned between the first and second regions 2202, 2204.

Advantageously, the above described arrangements help to reduce damage to the resistive heating element 342 during use as the most likely position of sparks and shorts, i.e. the contact points with the power source 220, is distal to and/or spaced from the resistive heating elements. Additionally, these arrangements also provides an additional layer of material between the heating elements to the rest of the device thereby protecting the other components from the relatively high temperature of the resistive heating layer. Furthermore, since the aerosol generating layer 330 is deposited on the resistive heating elements, these arrangements allows the electrical contacts to be provided away from the airflow path for carrying the aerosol generated from the aerosol generating layer. This helps to improve the quality of the aerosol delivered to the user as obstructions in the airflow path are minimised. Moreover, the above described arrangement also for more flexibility in the location of the device contacts which tends to reduce or avoid contamination by the generated aerosol.

The folding of the blank 2200 to form the aerosol generator 304 involves folding about first fold line 2208 in a first direction, e.g. clockwise or anti-clockwise and folding about second fold line 2209 in a second direction, e.g. anti-clockwise or clockwise. In other words, the folding may be considered to bring the “rear” portions of the blank 2200 (those without aerosol generating material) towards each other. In some embodiments, the first direction may be opposite to the second direction. This folding may be done until the first region 2202 and/or the first external region 2211 are perpendicular to the third region 2206. Similarly, the folding may be done until the second region 2204 and/or the second external region 2214 are perpendicular to the third region 2206. The folding of the blank 2200 to form the aerosol generator 304 may also involve folding about the third fold line 2210 in the same direction as the folding about the first fold line, i.e. the first direction. The folding of the blank 2200 to form the aerosol generator 304 may also involves folding about fourth fold line 2212 in the same directions as the folding about the second fold line 2209, i.e. in the second direction.

The connecting region 2206 has all the same features as the connecting region 1906 discussed in FIGS. 19A and 19B except that the connecting region 2206 comprises extra fold lines. As such, repeat description of these same features have been omitted.

Advantageously, the above described arrangement allows for an increase in the number of heating zones (corresponding to a resistive heating element) provided while reducing and/or minimizing the number of electrical contacts. For example, this may be due to the first and second resistive heating layers sharing the first type of electrical contacts. Similarly, the resistive heating elements of each resistive heating layer also share a second type of electrical contact. Moreover, the capability for individual activation is not sacrificed to achieve this advantage.

FIG. 23A shows an aerosol generating article 300. The aerosol generating article 300 comprises an aerosol generator 304, a core 2304, and a cover 2306. The aerosol generator 304 may be considered to be the blank 2200 as described in FIG. 22 or the aerosol generator 304 described in FIG. 21. Again, repeat descriptions of the same features are omitted. The aerosol generating article 300 also comprises an inlet (not shown) from which air can enter the airflow path. The aerosol generating article 300 also comprises an outlet (not shown) from which a user may inhale the air in the airflow path (which may contain the generated aerosol).

The core 2304 is positioned between the first and second resistive heating layers of the aerosol generator 304. The core 2304 may be considered to be a spacer. This may be done by folding the aerosol generator 304 around the core 2304 such that the core 2304 separates the first and second resistive heating layers and any aerosol generating layers thereon. Alternatively, the aerosol generator 304 may be first folded and then the core moved in between the first and second resistive heating layers. In this embodiment, the core has a thickness that is the same as the distance between the first and second resistive heating layers. In other embodiments, the core does not have a thickness that is the same as the distance between the first and second resistive heating layers, e.g. the core has a thickness that is greater than or less than the distance between the first and second resistive heating layers.

The cover 2306 is configured to be wrapped around the external surfaces of the aerosol generator 304. In this embodiment, the length of the cover 2306 is the same as the length of the aerosol generator 304 along the longitudinal direction. In other embodiments, the length of the cover is not the same as the length of the aerosol generator along the longitudinal direction, e.g. the length of the cover may be longer or shorter than the length of the aerosol generator. In this embodiment, the width of the cover 2306 is equal to the width of the first resistive heating layer combined with the width of the second resistive heating layer and combined with the twice the width of the connecting portion in the lateral direction. In other embodiments, the width of the cover can be greater or smaller.

Advantageously, the cover tends protects the electrical contacts on the external surfaces from damage when being handled.

In the above embodiments, each of the fold lines are not pre-formed on the blank. In other embodiments, one or more the fold lines are pre-formed on the blank, e.g. a crease, or indent, or score, or any other weakening of the electrical contact and/or the support layer thereon.

FIG. 23B shows a cut away view of the article 300 in an assembled state. The article 300 has the aerosol generator 304 arranged to be surrounding the core 2304. As described above, this may be done by folding the aerosol generator 304 around the core 2304. The cover 2306 is wrapped around the outer surface of the aerosol generator 304. The cover 2306 defines the external surface of the article 300. It is noted that FIG. 23B shows the view with a side portion of the core 2304 cut to show the internal structure. In this embodiment, the core 2304 completely closes off the airflow path to the outside environment except for the inlet and outlet. In other embodiments, the core 2304 does not completely closes off the airflow path to the outside environment, e.g. the cover only partially closes off the airflow path or the core does not close off the airflow path. In this embodiment, the airflow path is completely isolated from the outside environment except for the inlet and outlet. In some embodiments, one or more of aerosol generator, aerosol generating article, and aerosol provision device may have structures that combine to at least partially isolate and/or control the airflow path from the outside environment. In other embodiments, the airflow path is partially exposed to the outside environment.

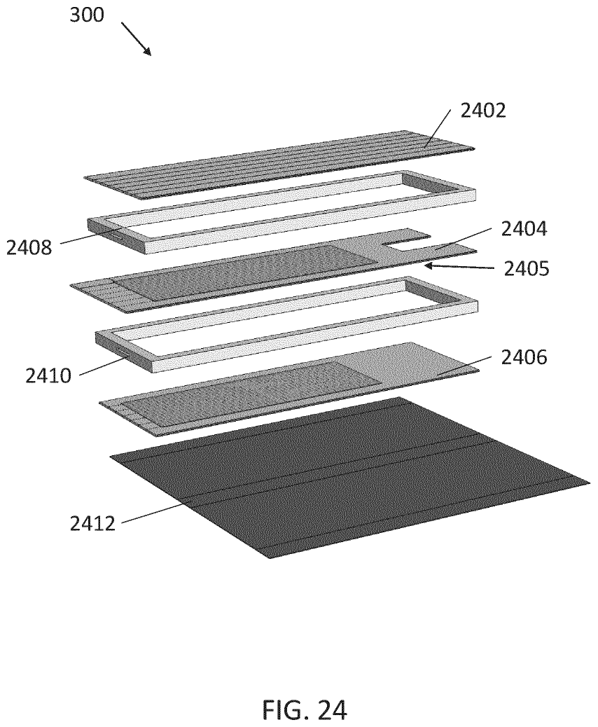

FIG. 24 shows a perspective view of various components of an alternative aerosol generating article 300. The aerosol generating article 300 comprises a first resistive heating layer 2402, a second resistive heating layer 2404, a third resistive heating layer 2405, a fourth resistive heating layer 2406, a first spacer 2408, a second spacer 2410, and a cover 2412. Each of the spacers 2408, 2410, and the cover 2412 are entirely optional and may be omitted. One or more of the spacers 2408, 2410 may be considered to be a core. One of the second and third resistive heating layers 2404, 2405 is also optional and may be omitted. The resistive heating layers in this embodiment is the same as the resistive heating layers discussed above. As such, repeated description of the resistive heating layers has been omitted.

The first and second resistive heating layers 2402, 2404 are positioned to be spaced apart from each other. The first and second resistive heating layers 2402, 2404 are also arranged such that the resistive heating elements of each of the layers face each other. As such, the aerosol generating layers of those layers also face each other. In this way, the first and second resistive heating layers 2402, 2404 define a first airflow path therebetween. In this embodiment, the first and second heating layers 2402, 2404 are spaced apart from each other by a first spacer 2408. In other embodiments, the first and second heating layers are not spaced apart from each other by the first spacer, e.g. the first and second heating layers are spaced apart from each by means other than a spacer.

The second and third resistive heating layer 2404, 2405 are positioned back to back. The second and third resistive heating layer 2404, 2405 are positioned to be adjacent each other. The second and third resistive heating layer 2404, 2405 are arranged such that their resistive heating elements face away from each other. For example, those resistive heating elements face opposite directions. In this embodiment, the second and third resistive heating layer 2404, 2405 abut/directly contact each other. In other embodiments, the second and third resistive heating layer 2404, 2405 may be spaced apart from each other.

The third and fourth resistive heating layers 2405, 2406 are positioned to be spaced apart from each other. The third and fourth resistive heating layers 2405, 2406 are also arranged such that the resistive heating elements of each of the layers face each other. As such, the aerosol generating layers of those layers also face each other. In this way, the third and fourth resistive heating layers 2405, 2406 define a second airflow path therebetween. In this embodiment, the third and fourth resistive heating layers 2405, 2406 are spaced apart from each other by a second spacer 2410. In other embodiments, third and fourth resistive heating layers are not spaced apart from each other by the second spacer, e.g. third and fourth resistive heating layers are spaced apart from each by means other than a spacer.

The first and fourth resistive heating layers 2402, 2406 are positioned such that their resistive heating elements and the aerosol generating layer deposited thereon faces inwards. The second and third resistive heating layers 2404, 2405 are positioned such that their resistive heating elements and the aerosol generating layer deposited thereon faces outwards.

The cover 2412 is wrapped around all the above-mentioned components to define an external surface of the aerosol generating article 300.

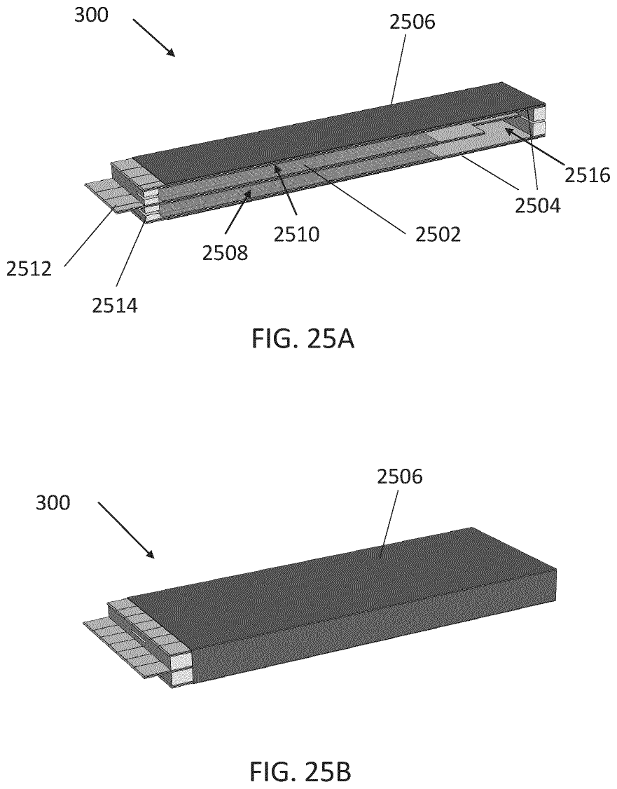

FIG. 25A shows a cut away perspective of an alternative aerosol generating article 300 having multiple airflow paths. The aerosol generating article 300 may be the same as the aerosol generating article 300 described in relation to FIG. 24. The aerosol generating article 300 comprises a first aerosol generator 304, a second aerosol generator 304, and a cover 2506. The cover 2506 is entirely optional and can be omitted. It is noted that the components described in relation to the aerosol generating article 300 of FIG. 24 may be also considered to be aforementioned features of aerosol generating article 300. For example, the first and fourth resistive heating layers 2402, 2406 may be considered to be second aerosol generator 304. Similarly, the second and third resistive heating layers 2404, 2405 may be considered to be first aerosol generator 304.

The first aerosol generator 304 is the aerosol generator 304 as described in relation to FIGS. 17 to 19. In other words, the first aerosol generator 304 may be considered to be a double-sided external facing aerosol generator. The second aerosol generator 304 is the aerosol generator 304 as described in relation to FIGS. 20 to 22. In other words, the second aerosol generator 304 may be considered to be a two layered internal facing aerosol generator. The first aerosol generator 304 is positioned between the resistive heating layers of the second aerosol generator 304. Each of the resistive heating layers of the first aerosol generator 304 is spaced apart from and faces a respective resistive heating layer of the second aerosol generator 304. The first aerosol generator 304 and the second aerosol generator 304 combine to define a first airflow path 2508 and a second airflow path 2510. The first airflow path 2508 is defined by a respective resistive heating layer of the first aerosol generator 304 and an opposing respective resistive heating layer of the second aerosol generator 304. Similarly, the second airflow path 2510 is also defined by a respective resistive heating layer of the first aerosol generator 304 and an opposing respective resistive heating layer of the second aerosol generator 304. The first and second type of electrical contacts of the first and second aerosol generators 304, 304 are all positioned at a longitudinal edge of the article 300.

Similar to the embodiment shown in FIG. 18, the article 300 further comprises an aperture 2516. The aperture 2516 has the features and functionality as the aperture described above in relation to FIG. 18. As such, repeat description of the aperture 2516 is omitted.

Advantageously, each of the above described arrangements allows for an increased amount of aerosol to be stored in the article without significantly increasing the size of the article. For example, this may allow for storage of different flavours (e.g. on each resistive heating layer) to be stored within the same article. Furthermore, the multiple airflow paths allow for greater range of operational modes for the article. For example, alternating airflow paths for each activation by the user allows for increased time for each of the airflow path to return to ambient/neutral conditions. Consecutive uses by a user may cause the airflow path to have increase temperature (from consecutive heatings) and/or have residual particulates. Alternating the airflow path between uses allows for the temperature to return to ambient levels and/or allows for the residual particulates to disperse. As such, this arrangement allows for improved performance.

The first and second type of electrical contacts 2512 of the first aerosol generator 304 is longitudinally offset from the first and second type of electrical contacts 2514 of the second aerosol generator 304. In this embodiment, the first and second type of electrical contacts of the first aerosol generator 304 extends longitudinally beyond the first and second type of electrical contacts of the second aerosol generator 304. Advantageously, this allows individual activations of each of the resistive heating elements on both the first and second aerosol generators without significantly complicating the connection to the power source.

FIG. 25B shows a perspective view of the aerosol generating article 300. The cover 2506 surrounds the first and second external portions. Since the first and second external portions contain electrical contacts, cover 2506 advantageously reduces or mitigates damage to the electrical contacts on the external portions, e.g. during handling.

In the above embodiments, there is only one first aerosol generator and only one second aerosol generator. In other embodiments, there is not only one first aerosol generator and only one second aerosol generator. In some embodiments, there may be a plurality of first aerosol generators positioned between the resistive heating layers of a second aerosol generator. In such embodiments, there may be at least three airflow paths each defined by at least two first aerosol generators or one of the first aerosol generators and the second aerosol generator.

In some embodiments, there may be one or more apertures in the blank, e.g. in the connecting portions, each of which corresponds to an inlet of a respective airflow path when the blank is formed into the aerosol generator. The arrangement described in relation to FIGS. 24 to 25 may be considered to be a stacked arrangement where various layers (such as resistive heating layers or spacers) are stacked on top of each other. The stacking may be in a direction perpendicular to the plane of one or more of the layers.

As mentioned above, in some embodiments of the different arrangements of articles described above the aerosol generating material comprises a solid or semi-solid material. In embodiments the aerosol generating layer comprises a solid material, for example reconstituted tobacco. The aerosol generating layer in such embodiments is in the form of an aerosol generating segment. The aerosol generating segment generally comprises a solid material. Such a solid material may be shredded tobacco. The aerosol generating material, arranged as an aerosol generating segment for example, may comprise a plurality of individual pieces of aerosol generating material. The aerosol generating material may be individual pieces of tobacco material. In embodiments, the aerosol generating material comprises a plurality of strips, beads or pellets. In embodiments the aerosol generating segment is a plug of material.

The aerosol generating segment in embodiments comprises a body of material. The aerosol generating material is a non-liquid. In such an embodiment, the body of material comprises a rod of aerosol generating material, for example a tobacco rod. For example, the body of material may comprise shredded tobacco material. The body of material may be formed into a rod. In some embodiments, the body of material comprises cut rag tobacco that is formed into a rod. The aerosol generating material may comprise tobacco material. The aerosol generating material may comprise extruded tobacco. The aerosol generating material may comprise reconstituted tobacco.

The aerosol generating material, formed as a solid material, may comprise nicotine. The aerosol generating material may comprises, consist of, or essentially consist of, tobacco. In embodiments, the aerosol generating material is free from tobacco.

In embodiments of any of the above, the heating of the article provides a relatively constant release of volatile compounds into an inhalable medium. In an embodiment of the above, the aerosol generating segment is a plug of material. The article may comprise a mouth end section. A tubular element may be located between the aerosol generating material and the mouth end section. The article may comprise a ventilation area in the mouth end section. The mouth end section may define a mouthpiece configured to be placed between a user's lips.

In embodiments of any of the above described articles, the or each resistive heating element is configured to heat substantially the entire aerosol generating material. The aerosol generating segment in embodiments is at least substantially cylindrical. In embodiments, the aerosol generating segment is at least partially wrapped by the resistive heating layer. In embodiments, the resistive heating element extends in the aerosol generating segment. The resistive heating element may extend around the aerosol generating segment. In embodiments, the resistive heating element encircles the aerosol generating segment. In some arrangements at least a portion of the flow path through the article is through the aerosol generating segment. The aerosol generating segment may define part of the air path. In embodiments, the first type of electrical contact and the second type of electrical contact are exposed from the aerosol generating segment.

The aerosol generating material may comprise tobacco material as described herein, which includes a tobacco component. In the tobacco material described herein, the tobacco component may contain paper reconstituted tobacco. The tobacco component may also contain leaf tobacco, extruded tobacco, and/or bandcast tobacco. The tobacco material may be provided in the form of cut rag tobacco. The cut rag tobacco can be formed from a mixture of forms of tobacco material, for instance a mixture of one or more of paper reconstituted tobacco, leaf tobacco, extruded tobacco and bandcast tobacco. In embodiments, the tobacco material comprises paper reconstituted tobacco or a mixture of paper reconstituted tobacco and leaf tobacco. In the tobacco material described herein, the tobacco material may contain a filler component. The filler component is generally a non-tobacco component, that is, a component that does not include ingredients originating from tobacco. The filler component may be a non-tobacco fibre such as wood fibre or pulp or wheat fibre. The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent. In the tobacco material described herein, the tobacco material contains an aerosol-former material. In this context, an “aerosol-former material” is an agent that promotes the generation of an aerosol. An aerosol-former material may promote the generation of an aerosol by promoting an initial vaporisation and/or the condensation of a gas to an inhalable solid and/or liquid aerosol. In some embodiments, an aerosol-former material may improve the delivery of flavour from the aerosol generating material. In general, any suitable aerosol-former material or agents may be included in the aerosol generating material of the invention, including those described herein.

Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibres) by deposition of the extract onto the fibrous material. The process of recombination resembles the process for making paper.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An article for an aerosol provision device, the article comprising:
an aerosol generating layer comprising aerosol generating material;
a resistive heating layer comprising a resistive heating element configured to heat at least a portion of the aerosol generating material to generate an aerosol;
the aerosol generating layer being on the resistive heating layer;
a first type of electrical contact; and
a second type of electrical contact;
wherein the resistive heating element is at least a portion of an electrically conductive path between the first type of electrical contact and the second type of electrical contact; and
wherein the article comprises an internal space defining a path along which, in use, aerosol generated from the aerosol generating layer is configured to flow.

2. The article of claim 1, further comprising a body defining the internal space.

3. The article of claim 2, wherein the body is tubular.

4. The article for an aerosol provision device of claim 1, wherein:
the aerosol generating layer is a first aerosol generating layer;
the resistive heating layer is a first resistive heating layer;
the article further comprises:
a second aerosol generating layer comprising a second aerosol generating material; and
a second resistive heating layer comprising a second resistive heating element configured to heat at least a portion of the second aerosol generating material to generate an aerosol;
the second aerosol generating layer being on the second resistive heating layer;
wherein the second resistive heating element is at least a portion of an electrically conductive path between the first type of electrical contact and the second type of electrical contact; and
wherein the internal space is defined between the first and second resistive heating layers.

5. The article of claim 4, wherein the first type of electrical contact comprises a common electrical contact from which both the first and second resistive heating elements extend from.

6. The article of claim wherein:
the second type of electrical contact comprises two electrical contacts electrically separate from each other; and
the first resistive heating element extend extends from one of the electrical contacts and the second resistive heating element extends from the other one of the electrical contacts.

7. The article of claim 6, wherein:
the first resistive heating layer comprises a plurality of first resistive heating elements, each of which is a portion of a respective electrically conductive path between a respective first type of electrical contact and one of the electrical contacts of the second type of electrical contact; and
the second resistive heating layer comprises a plurality of second resistive heating elements, each of which is a portion of a respective electrically conductive path between a respective first type of electrical contact and the other electrical contact of the second type of electrical contact.

8. The article of claim 4, further comprising a connecting portion coupled to the first resistive heating layer by a first fold at one end and coupled to the second resistive heating layer by a second fold at the other end.

9. The article of claim 8, wherein each of the connecting portion and the first and second resistive heating layers are formed from a single sheet of material.

10. The article of claim 4, wherein the first and second resistive heating layers face each other.

11. The article of claim 4, further comprising an aerosol generator positioned in the internal space between the first and second resistive heating layers, the aerosol generator comprising:
a third aerosol generating layer comprising aerosol generating material;
a third resistive heating layer comprising a third resistive heating element configured to heat aerosol generating material of the third aerosol generating layer to generate an aerosol;
the third aerosol generating layer being on the third resistive heating layer;
a fourth aerosol generating layer comprising aerosol generating material;
a fourth resistive heating layer comprising a fourth resistive heating element configured to heat at least the aerosol generating material of the fourth aerosol generating layer to generate an aerosol; and
the fourth aerosol generating layer being on the fourth resistive heating layer;
wherein each resistive heating element is at least a portion of an electrically conductive path between a first type of electrical contact and a second type of electrical contact.

12. The article of claim 11, wherein:
the third aerosol generating layer is positioned spaced apart from the first aerosol generating layer and defines a first airflow path therebetween; and
the fourth aerosol generating layer is positioned spaced apart from the second aerosol generating layer and defines a second airflow path therebetween.

13. The article of claim 11, wherein the first and second type of electrical contacts of the third and/or fourth resistive heating layers are displaced along the longitudinal direction from the first and second type of electrical contacts of the first and/or second resistive heating layers.

14. The article of claim 11, wherein the second type of electrical contact of the third and/or fourth resistive heating layers comprises two electrical contacts electrically separate from each other;
wherein the third resistive heating element extends from one of the electrical contacts and the fourth resistive heating element extends from the other one of the electrical contacts.

15. The article of claim 14, wherein:
the third resistive heating layer comprises a plurality of third resistive heating elements, each of which is a portion of a respective electrically conductive path between a respective first type of electrical contact and one of the second type of electrical contacts; and
the fourth resistive heating layer comprises a plurality of fourth resistive heating elements, each of which is a portion of a respective electrically conductive path between a respective third type of electrical contact and the another of the second type of electrical contact.

16. The article of claim 15, wherein:
the first type of electrical contact comprises a plurality of electrical contacts; and
a respective third resistive heating element and a respective fourth resistive heating elements share a respective one of the plurality of electrical contacts of the first type of electrical contact.

17. A blank for forming an aerosol generating material, the blank comprising:
one or more resistive heating elements, each of which is configured to generate heat;
a first type of electrical contact;
a second type of electrical contact;
wherein each of the one or more resistive heating elements is at least a portion of an electrically conductive path between the first type of electrical contact and the second type of electrical contact;
wherein the blank is configured to form an internal space defining a path along air can flow; and
wherein the path is adjacent to the one or more resistive heating elements.

18. The blank of claim 17, the blank further comprising:
a first region comprising a first resistive heating element configured to generate heat;
a second region comprising a second resistive heating element configured to generate heat;
a first fold line positioned between the first and second regions; and
a second fold line spaced apart from the first fold line and positioned between the first and second regions;
wherein each of the first and second resistive heating elements is at least a portion of a respective electrically conductive path between a respective first type of electrical contact and a second type of electrical contact;
wherein folding the blank about the first and second fold lines results in the first and second portions each forming a respective layer where the first and second resistive heating elements face towards from each other.

19. The blank of claim 18, wherein:
the first type of electrical contact is common both the first and second regions;
the first type of electrical contact is positioned between the first and second regions; and
each of the first and second fold lines is positioned on the first type of electrical contact.

20. A method of manufacturing an article, the method comprising:
providing a blank of claim 18;
depositing an aerosol generating layer comprising aerosol generating material on the first and/or second portions such that the first and/or second resistive heating elements can heat the aerosol generating material to generate an aerosol;
folding a sheet about the first fold line; and
folding the blank about the second fold line.
